(19) United States
(12) Patent Application Publication
(10) Pub. No.: US 2011/0076951 A1
(43) Pub. Date: Mar. 31, 2011

(54) INFORMATION PROCESSING APPARATUS

(75) Inventor: Ryo Hatano, Kodaira-shi (JP)

(73) Assignee: KABUSHIKI KAISHA TOSHIBA, Tokyo (JP)

(21) Appl. No.: 12/856,443

(22) Filed: Aug. 13, 2010

(30) Foreign Application Priority Data
Sep. 30, 2009 (JP) 2009-228905

(51) Int. Cl. H04B 7/005

(52) U.S. Cl. 455/41.3; 455/41.2

(57) ABSTRACT

According to one exemplary embodiment, an information processing apparatus is provided with: a wireless communication module configured to perform a wireless communication with a counterpart communication apparatus that is detected to be in a given range from the wireless communication module; and a controller configured to control the wireless communication. The controller is configured to determine whether a condition for starting to perform the wireless communication is satisfied when the counterpart communication apparatus is detected by the wireless communication module, and to control the wireless communication module to start performing the wireless communication when the controller determines that the condition is satisfied.

### CROSS REFERENCE TO RELATED APPLICATION(S)

The present disclosure relates to the subject matters contained in Japanese Patent Application No. 2009-228905 filed on Sep. 30, 2009, which are incorporated herein by reference in its entirety.

### BACKGROUND

1. Field

One exemplary embodiment of the invention relates to an information processing apparatus having a wireless communication function.

2. Description of the Related Art

Measures for preventing occurrence of human errors in making operations are taken in electronic apparatuses.

For example, a time taken from a request for staring a processing until starting the processing is controlled according to a level of risk. A related art requests a user to continue to press a button for a longer time than usual when the processing is considered riskier. For example, in an automated teller machine (ATM), when a large amount of money is to be handled, a transition to the next processing is prohibited unless the user continues to press an enter button for a given time. Setting a longer operation time for riskier processing gives the user an opportunity to reconsider whether the operations are proper and no error is made (For example, please see JP-A-2008-225839 (KOKAI)).

In recent years, electronic apparatuses having a short-range wireless communication function have become widely used. There are various standards that relate to the short-range wireless communication, and among them there is a standard in which a wireless communication is started when it is detected that a counterpart communication apparatus is entered into a communication range. In this scheme, it is not necessary to search for, select, or authenticate a communication partner and a communication can be established merely by bringing two communication apparatuses close to each other.

In the above-described wireless communication scheme, a wireless communication can be started easily. However, the wireless communication is started even when the user inadvertently brings two communication apparatuses close to each other. The wireless communication that is not intended by the user may cause leakage of data. Therefore, in the wireless communication scheme in which the wireless communication can be established when it is detected that the counterpart communication apparatus is entered into the communication range, it is necessary to impose another condition on establishment of the wireless communication.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate exemplary embodiments of the invention and not to limit the scope of the invention.

FIG. 1 is a perspective view showing an appearance of a personal computer according to exemplary embodiments;

FIG. 2 is a functional block diagram showing the personal computer according to the exemplary embodiments;

FIG. 3 is a flowchart showing a communication control process according to a first exemplary embodiment;

FIG. 4 is a flowchart showing a communication control process according to a second exemplary embodiment;

FIG. 5 is a flowchart showing a communication control process according to a third exemplary embodiment; and

FIG. 6 is a flowchart showing a communication control process according to a fourth exemplary embodiment.

### DETAILED DESCRIPTION

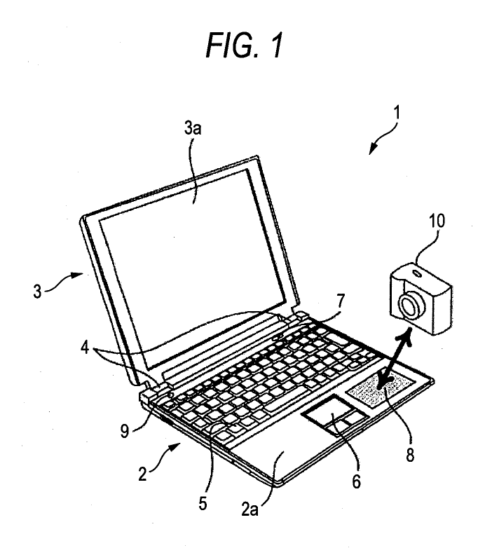

Exemplary embodiments of the present invention will be hereinafter described with reference to FIGS. 1-6. The exemplary embodiments are directed to a personal computer 1 which is an example information processing apparatus. FIG. 1 is a perspective view showing an appearance of the personal computer 1 according to the exemplary embodiments.

The personal computer 1 is provided with a main unit 2 and a display unit 3 which are connected to each other by hinges 4 so as to be rotatable with respect to each other. For example, the display unit 3 incorporates a display device 3a which is a liquid crystal display (LCD).

The main unit 2 is provided with a main housing 2a, a keyboard 5, a touch pad 6, a power switch 7, a communication module 8, and a button 9.

The main housing 2a has a thin box shape and houses various electronic components, disc drives, etc. A top surface of the main housing 2a is provided with input devices such as the keyboard 5 and the touch pad 6.

The keyboard 5 is an input device that is provided in the top surface of the main housing 2a. A signal corresponding to an operation key of the keyboard 5 is output to individual units. A given key of the keyboard 5 is used for making an instruction to start a wireless communication that is to be performed by the communication module 8.

The touch pad 6 is a pointing device that is provided in the top surface of the main housing 2a. A signal corresponding to an operation of the touch pad 6 is output to individual units.

The power switch 7 generates a control signal for powering on or off the personal computer 1 in response to an operation by the user.

The communication module 8 is a module for performing the wireless communication with a communication apparatus 10 which is, for example, a digital camera or a cell phone having a wireless communication function. The communication module 8 performs data communication of a video, music, or the like with the communication apparatus 10 by the wireless communication. The wireless communication is established when the communication apparatus 10 is entered into a communication range and is detected. That is, the communication module 8 can establish the wireless communication without searching for, select, or authenticate a communication partner. A communication distance of the wireless communication is assumed to be several centimeters, and the wireless communication is performed with the communication apparatus 10 that is placed on a portion of the main housing 2a which corresponds to the communication module 8.

The button 9 is an input device for making an instruction to start the wireless communication.

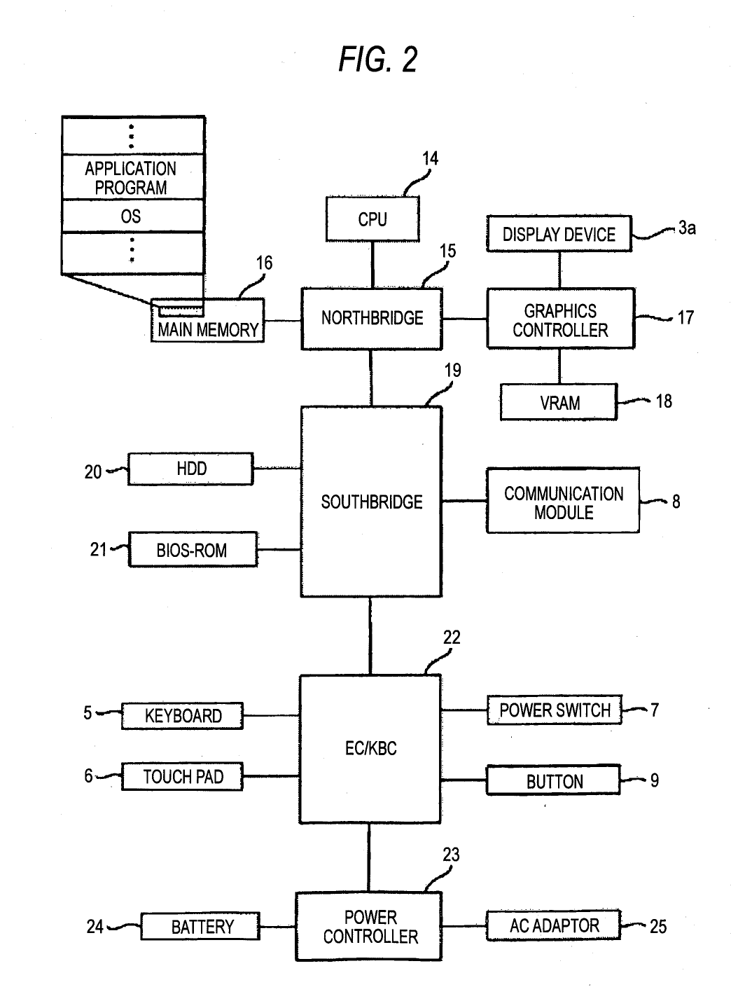

FIG. 2 is a functional block diagram showing the personal computer 1 according to the exemplary embodiments. The personal computer 1 is provided with the display device 3a, the keyboard 5, the touch pad 6, the power switch 7, the communication module 8, the button 9, a central processing unit (CPU) 14, a northbridge 15, a main memory 16, a graphics controller 17, a video random access memory (VRAM) 18, a southbridge 19, a hard disk drive (HDD) 20, a basic input/output system read only memory (BIOS-ROM) 21, an embedded controller/keyboard controller (EC/KBC) 22, a power controller 23, a battery 24, and an alternating current (AC) adaptor 25.

The display device 3a displays a video based on a video signal that is input from the graphics controller 17.

The CPU 14, which is a processor provided for controlling the operations of the personal computer 1, performs an operating system and various application programs that are loaded into the main memory 16 from the HDD 20. The CPU 14 also performs a system BIOS which is stored in the BIOS-ROM 21 after the system BIOS is loaded into the main memory 16. The system BIOS is a program for hardware control. In the exemplary embodiments, the CPU 14 performs an application relating to the wireless communication and controls the wireless communication that is performed by the communication module 8.

The northbridge 15 is a bridge device that connects a local bus of the CPU 14 and the southbridge 19. The northbridge 15 incorporates a memory controller which access-controls the main memory 16. The northbridge 15 also has a function of performing a communication with the graphics controller 17 via an accelerated graphics port (AGP) bus or the like.

The main memory 16 is a working memory for developing the operating system and the various application programs stored in the HDD 20 and the system BIOS stored in the BIOS-ROM 21.

The graphics controller 17 is a display controller for controlling the display device 3a which is used as a display monitor of the personal computer 1. The graphics controller 17 generates a video signal of a display image to be displayed on the display device 3a based on display data that is stored in the VRAM 18 by the operating system and the application program.

The southbridge 19 controls access to the BIOS-ROM 21 and also controls the disc drives (I/O devices) such as the HDD 20 and an optical disc drive (ODD). In the exemplary embodiments, the communication module 8 which performs the wireless communication with an external apparatus is connected to the southbridge 19.

The HDD 20 is a storage device for storing the operating system, the various application programs, etc. In the exemplary embodiments, the application program relating to the wireless communication is stored in the HDD 20.

The BIOS-ROM 21 is a rewritable nonvolatile memory for storing the system BIOS which is a program for the hardware control.

The EC/KBC 22 is a one-chip microcomputer for monitoring and controlling various devices (peripheral devices, sensors, a power circuit, etc.) irrespective of a system status of the personal computer 1. That is, the EC/KBC 22 controls the input devices such as the keyboard 5 and the touch pad 6.

When external power is supplied via the AC adaptor 25, the power controller 23 generates system power to be supplied to the individual components of the personal computer 1 using the external power. When the external power is not supplied via the AC adaptor 25, the power controller 23 generates system power to be supplied to the individual components of the personal computer 1 using the battery 24.

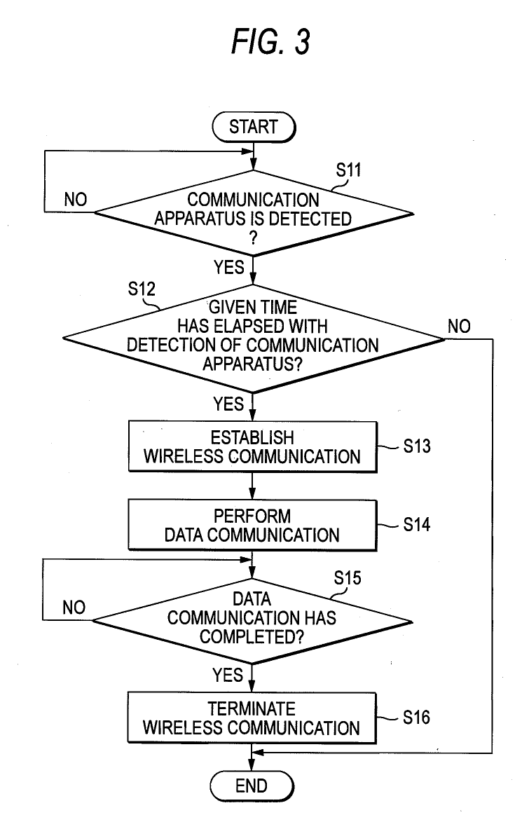

Next, a first exemplary embodiment of the invention will be described with reference to FIG. 3.

In the first exemplary embodiment, a wireless communication is started when a given time has elapsed in a state that the communication module 8 continues to detect the communication apparatus 10. For example, when the user inadvertently brings the communication apparatus 10 close to the communication module 8, usually the user immediately moves the communication apparatus 10 away from the communication module 8. Accordingly, it is determined whether the user brings the communication apparatus 10 close to the communication module 8 to perform the wireless communication by determining whether a state that the communication apparatus 10 and the communication module 8 are close to each other continues for more than or equal to the given time.

That is, if the time for detecting the communication apparatus 10 in the communication module 8 is shorter than the given time, the wireless communication is not started by determining that the wireless communication is not intended. On the other hand, the time for detecting the communication apparatus 10 in the communication module 8 is longer than or equal to the given time, the wireless communication is started by determining that the communication apparatus 10 is kept close to the communication module 8 to perform the wireless communication.

FIG. 3 is a flowchart showing a communication control process according to the first exemplary embodiment. In the communication control process, the CPU 14 performs the application program relating to the wireless communication.

First, in step S11, the CPU 14 determines whether the communication module 8 detects the communication apparatus 10, that is, whether the communication apparatus 10 exists within the communication distance of the communication module 8. If it is determined that the communication apparatus 10 is not detected (NO in step S11), the process returns to step S11. On the other hand, if it is determined that the communication module 8 detects the communication apparatus 10 (YES in step S11), the CPU 14 determines in step S12 whether the given time has elapsed in a state that the communication apparatus 10 continues to be detected. Time measurement is performed by, for example, a clock that is incorporated in the CPU 14.

If it is determined that the given time has not elapsed yet in a state that the communication apparatus 10 continues to be detected (No in step S12), the communication control process is finished. That is, the wireless communication is not performed by determining that the communication apparatus 10 is brought close to the communication module 8 accidentally by an erroneous action of the user rather than for the wireless communication.

On the other hand, if it is determined that the given time has elapsed in a state that the communication apparatus 10 continues to be detected (YES in step S12), in step S13 the CPU 14 establishes the wireless communication with the communication apparatus 10. That is, the wireless communication is started by determining that the communication apparatus 10 is brought close to the communication module 8 for the wireless communication. It step S13, the user may be informed of starting the wireless communication by outputting a sound from speakers or lighting an indicator.

In step S14, the CPU 14 performs data communication with the communication apparatus 10. For example, data stored in a specified folder of the communication apparatus 10 is transmitted to the personal computer 1 and the personal computer 1 stores the received data in the HDD 20.

In step S15, the CPU 14 determines whether the data communication completes or not, that is, whether the data communication of all the data stored in the specified folder completes or not.

If it is determined that the data communication has not completed yet (No in step S15), the process returns to step S15. On the other hand, if it is determined that the data communication has completed (YES in step S15), the CPU 14 terminates the wireless communication. The communication control process according to the first exemplary embodiment is thus finished.

According to the first exemplary embodiment, since it is determined whether a state that the communication apparatus 10 is brought close to the communication module 8 is maintained for the given time, an event that the wireless communication with the communication apparatus 10 is started by an erroneous action of the user can be prevented. Therefore, it is possible to prevent data leakage due to execution of the wireless communication that is not intended by the user.

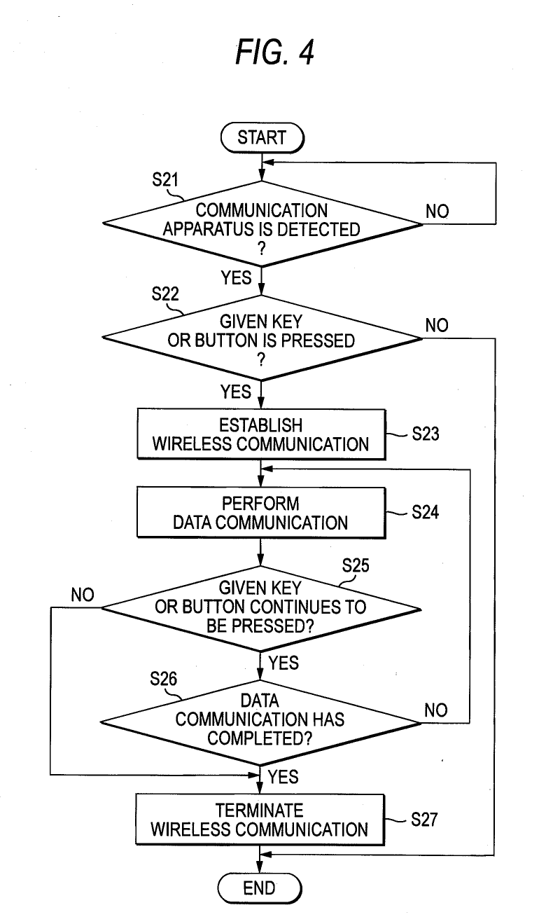

Next, a second exemplary embodiment of the invention will be described with reference to FIG. 4. FIG. 4 is a flowchart showing a communication control process according to the second exemplary embodiment.

In the second exemplary embodiment, a wireless communication is performed only during a period when a given key of the keyboard 5 or the button 9 is pressed in a state that the communication apparatus 10 is brought close to the communication module 8.

First, in step S21, the CPU 14 determines whether the communication module 8 detects the communication apparatus 10. If it is determined that the communication apparatus 10 is not detected (No in step S21), the process returns to step S21. On the other hand, if it is determined that the communication module 8 detects the communication apparatus 10 (YES in step S21), the CPU 14 determines in step S22 whether a given key of the keyboard 5 or the button 9 is pressed or not. The user may be either caused to recognize in advance that the wireless communication is performed only during a period when the given key of the keyboard 5 or the button 9 is pressed or caused to recognize that each time by displaying a screen that prompts pressing of the given key or the button 9.

If it is determined that the given key or the button 9 is not pressed (No in step S22), the communication control process is finished. That is, the wireless communication is not performed by determining that the communication apparatus 10 is brought close to the communication module 8 accidentally by an erroneous action of the user rather than for the wireless communication.

On the other hand, if it is determined that the given key or the button 9 is pressed (YES in step S22), in step S23 the CPU 14 establishes the wireless communication with the communication apparatus 10.

In step S24, the CPU 14 performs data communication with the communication apparatus 10. In step S25, the CPU 14 determines whether the given key or the button 9 continues to be pressed. That is, continuous pressing of the given key or the button 9 is a condition for continuation of the wireless communication. The wireless communication is performed only during a period when the given key or the button 9 is pressed.

If it is determined that the continuation of the pressing of the given key or the button 9 has finished (No in step S25), the process moves to step S27. On the other hand, if it is determined that the given key or the button 9 continues to be pressed (YES in step S25), in step S26 the CPU 14 determines whether the data communication has completed or not.

If it is determined that the data communication has not completed yet (NO in step S26), the process returns to step S24. On the other hand, if it is determined that the data communication has completed (YES in step S26), the CPU 14 terminates the wireless communication. The communication control process according to the second exemplary embodiment is thus finished.

According to the second exemplary embodiment, since pressing of the given key of the keyboard 5 or the button 9 in a state that the communication apparatus 10 is brought close to the communication module 8 is employed as a condition for continuation of the wireless communication, an event that the wireless communication is performed by an erroneous action of the user can be prevented. That is, according to the second exemplary embodiment, execution of the wireless communication requires the user to perform two actions, that is, bringing the communication apparatus 10 close to the communication module 8 and continuing to press the given key or the button 9. Therefore, it is possible to prevent the wireless communication that is not intended by the user.

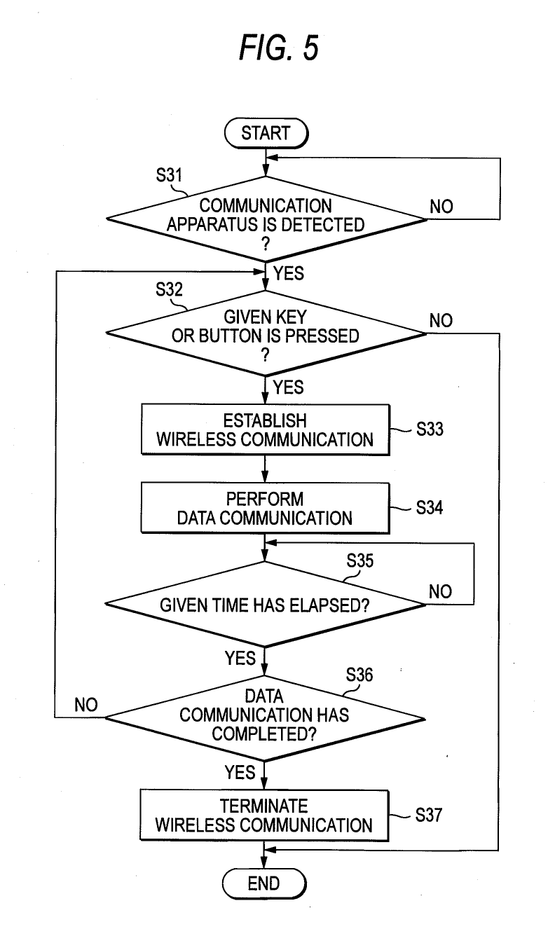

Next, a third exemplary embodiment of the invention will be described with reference to FIG. 5. FIG. 5 is a flowchart showing a communication control process according to the third exemplary embodiment.

In the third exemplary embodiment, a wireless communication is performed only for a given time after a given key of the keyboard 5 or the button 9 is pressed in a state that the communication apparatus 10 is brought close to the communication module 8.

First, in step S31, the CPU 14 determines whether the communication module 8 detects the communication apparatus 10. If it is determined that the communication apparatus 10 is not detected (NO in step S31), the process returns to step S31. On the other hand, if it is determined that the communication module 8 detects the communication apparatus 10 (YES in step S31), the CPU 14 determines in step S32 whether the given key of the keyboard 5 or the button 9 is pressed or not.

If it is determined that the given key or the button 9 is not pressed (NO in step S32), the communication control process is finished.

On the other hand, if it is determined that the given key or the button 9 is pressed (YES in step S32), in step S33 the CPU 14 establishes the wireless communication with the communication apparatus 10. A sound for notifying the user of the establishment of the wireless communication may be output. In step S34, the CPU 14 performs data communication with the communication apparatus 10.

In step S35, the CPU 14 determines whether a given time has elapsed or not. Time measurement is performed by, for example, a clock that is incorporated in the CPU 14. If it is determined that the given time has not elapsed yet (NO in step S35), the process returns to step S35. On the other hand, if it is determined that the given time has elapsed (YES in step S35), in step S36 the CPU 14 determines whether the data communication has completed or not. If it is determined that the data communication has not completed yet (NO in step S36), the process returns to step S32. On the other hand, if it is determined that the data communication has completed (YES in step S36), the CPU 14 terminates the wireless communication. That is, the wireless communication is performed only for the given time after pressing the given key or the button 9. The communication control process according to the third exemplary embodiment is thus finished.

According to the third exemplary embodiment, the wireless communication is enabled only for the given time after pressing the given key or the button 9. That is, to start the wireless communication, the user is required to perform an action of pressing the given key or the button 9. Therefore, it is possible to prevent the wireless communication that is not intended by the user.

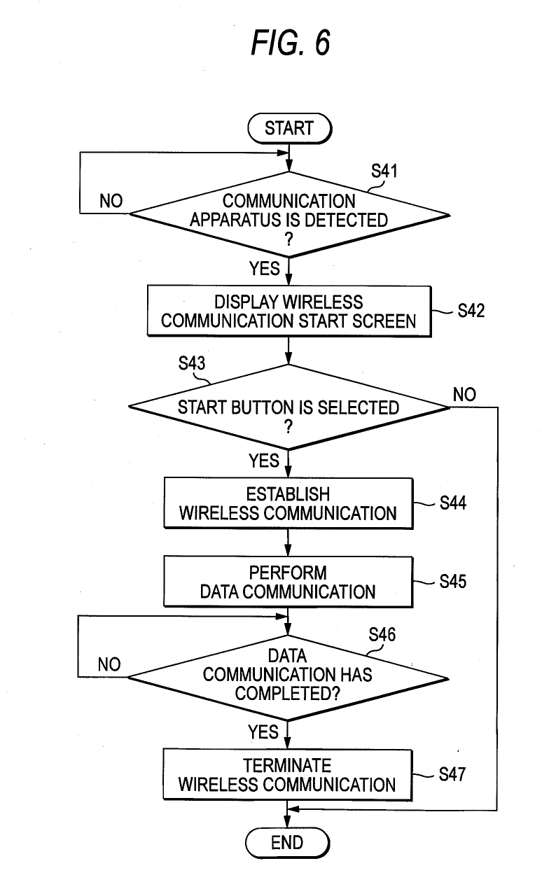

Next, a fourth exemplary embodiment of the invention will be described with reference to FIG. 6. FIG. 6 is a flowchart showing a communication control process according to the fourth exemplary embodiment.

In the fourth exemplary embodiment, a wireless communication is performed when execution of the wireless communication is selected in a screen displayed on the display unit 3 in a state that the communication apparatus 10 is brought close to the communication module 8.

First, in step S41, the CPU 14 determines whether the communication module 8 detects the communication apparatus 10. If it is determined that the communication apparatus 10 is not detected (NO in step S41), the process returns to step S41. On the other hand, if it is determined that the communication module 8 detects the communication apparatus 10 (YES in step S41), in step S42 the CPU 14 displays a wireless communication start screen on the display unit 3. More specifically, the CPU 14 displays the wireless communication start screen by controlling the graphics controller 17 to generate a video signal and outputting the generated video signal in the display device 3a. The wireless communication start screen includes a button to be used for selecting whether the wireless communication is started or not.

In step S43, the CPU 14 determines whether a start of the wireless communication is selected in the wireless communication start screen. If it is determined that the start of the wireless communication is not selected (NO in step S43), the communication control process is finished. That is, the wireless communication is not performed unless the start of the wireless communication is selected in the wireless communication start screen.

On the other hand, if it is determined that the start of the wireless communication is selected in the wireless communication start screen (YES in step S43), in step S44 the CPU 14 establishes the wireless communication with the communication apparatus 10. In step S45, the CPU 14 performs data communication with the communication apparatus 10.

In step S46, the CPU 14 determines whether the data communication has completed or not. If it is determined that the data communication has not completed yet (NO in step S46), the process returns to step S46. On the other hand, if it is determined that the data communication has completed (YES in step S46), the CPU 14 terminates the wireless communication with the communication apparatus 10. The communication control process according to the fourth exemplary embodiment is thus finished.

According to the fourth exemplary embodiment, the wireless communication is enabled only when the start of the wireless communication is selected in the wireless communication start screen. That is, employing an operation on a screen displayed on the display device 3a as a condition that is necessary for the start of the wireless communication prevents execution of an unintended wireless communication and thereby prevents leakage of information.

Although in the fourth exemplary embodiment the wireless communication is performed when the button displayed on the display device 3a is operated, the invention is not limited to such a case. For example, a wireless communication may be performed while the button displayed on the display device 3a is kept operated or for a given time after operation of the button.

The present invention is not limited to the foregoing embodiments but various modifications of its component may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An information processing apparatus comprising:
a wireless communication module configured to wirelessly communicate with a counterpart communication apparatus that is detected to be in a predetermined range from the wireless communication module; and
a controller configured to control the wireless communication,
wherein the controller is configured to determine whether a condition for starting the wireless communication is satisfied when the counterpart communication apparatus is detected by the wireless communication module, and to control the wireless communication module to start the wireless communication when the controller determines that the condition is satisfied.

2. The apparatus of claim 1, wherein the controller is configured to control the wireless communication module to start the wireless communication after an elapse of a predetermined time since the wireless communication module detects the counterpart communication apparatus to be in the predetermined range.

3. The apparatus of claim 1 further comprising:
a user interface configured to input a signal generated according to an input operation to the controller,
wherein the controller is configured to control the wireless communication module to start the wireless communication after receiving the signal.

4. The apparatus of claim 3, wherein the wireless communication module is configured to execute the wireless communication during a period when the controller continues to receive the signal.

5. The apparatus of claim 3, wherein the wireless communication module is configured to execute the wireless communication for a predetermined period since the controller receives the signal.

6. The apparatus of claim 1 further comprising:
a display configured to display a screen for selecting to start the wireless communication,
wherein the controller is configured to control the wireless communication module to start the wireless communication when the controller determines that the wireless communication is selected to be started.
